(19) United States
(12) Patent Application Publication
(10) Pub. No.: US 2014/0283982 A1
(43) Pub. Date: Sep. 25, 2014

(54) UNIVERSAL NANOPATTERNABLE INTERFACIAL BONDING

(71) Applicant: The Regents of the University of California, Oakland, CA (US)

(72) Inventors: Tingrui Pan, Woodland, CA (US); Yuzhe Ding, Davis, CA (US); Shaun P. Garland, Davis, CA (US)

(21) Appl. No.: 14/350,307

(22) PCT Filed: Oct. 21, 2012
(86) PCT No.: PCT/US2012/061240

§ 371 Date: Apr. 7, 2014

Related U.S. Application Data
(60) Provisional application No. 61/549,885, filed on Oct. 21, 2011.

(51) Int. Cl. B32B 37/00; B32B 38/00; B32B 37/14

(52) U.S. Cl. CPC B32B 37/0038; B32B 37/14; B32B 38/0012
USPC 156/219; 156/308.6; 156/273.3; 156/272.6; 427/240; 156/390; 156/556; 156/379.8; 118/56

(57) ABSTRACT

One embodiment of the present invention provides a system for bonding a first substrate and a second substrate. During operation, the system starts by treating a first surface of the first substrate and a second surface of the second substrate with a hydrophilic treatment. The system then transfers a first oligomer layer onto the treated first surface and a second oligomer layer onto the treated second surface. Next, the system treats the first oligomer layer and the second oligomer layer for hydrophilic activation. The system subsequently brings the first oligomer layer into contact with the second oligomer layer, thereby allowing the two oligomer layers to adhere and form a single bonding layer between the first substrate and the second substrate. In particular, each of the first oligomer layer and the second oligomer layer is a polydimethylsiloxane (PDMS) layer.

### BACKGROUND

1. Field

The present invention generally relates to interfacial bonding techniques. More specifically, the present invention relates to techniques for joining two substrates of the same or different material types with the assistance of polydimethylsiloxane (PDMS).

2. Related Art

As the development of micro- and nanoscale systems for material and biological investigations progresses, joining heterogeneous surfaces has become an increasingly pressing issue where multiple processing constraints have to be taken into consideration as a whole, e.g., specific material sensitivities to mechanical, thermal, and/or chemical treatments. Based on the underlying physical and chemical mechanisms, existing surface bonding techniques can be divided into three major categories: thermal-based, chemical-based, and adhesive-based bonding techniques.

Thermal-based bonding techniques, often accompanied with heavy mechanical loads, employ the accelerated diffusion process under high temperature to form hermetic seals. However, these techniques are typically incompatible with soft materials. Chemical-based bonding techniques operate by introducing functional groups onto the bonding surfaces. Through dedicated chemical reactions, chemical bonds form strong covalent or ionic linkages between the bonding surfaces. However, those approaches are highly material-dependent and therefore have very limited applicability. Adhesive-based bonding techniques are designed to physically join two surfaces through the formation of an intermediate adhesive layer. Unfortunately, the semi-fluid nature (known as viscoelasticity) of adhesives can be destructive to micro/nanostructures fabricated in the vicinity of the bonding surfaces, thereby causing structural deformation and passage blockage.

Hence, what is needed is an interfacial bonding technique which can be applied to a wide range of bonding surface-material selections for building complex multilayer micro- and nanostructures from different material types without the above-described problems.

### SUMMARY

One embodiment of the present invention provides a system for bonding a first substrate and a second substrate. During operation, the system starts by treating a first surface of the first substrate and a second surface of the second substrate with a hydrophilic treatment. The system then transfers a first oligomer layer onto the treated first surface and a second oligomer layer onto the treated second surface. Next, the system treats the first oligomer layer and the second oligomer layer for hydrophilic activation. The system subsequently brings the first oligomer layer into contact with the second oligomer layer, thereby allowing the two oligomer layers to adhere and form a single bonding layer between the first substrate and the second substrate. In particular, each of the first oligomer layer and the second oligomer layer is a polydimethylsiloxane (PDMS) oligomer layer.

In some embodiments, the system transfers a PDMS oligomer layer on the treated first surface or the treated second surface by imprinting a PDMS stamp on the treated first surface or the treated second surface to cause a PDMS oligomer layer to form on the treated first surface or the treated second surface.

In some embodiments, after transferring the PDMS oligomer layer on the treated first surface or the treated second surface, the system removes the PDMS stamp from the PDMS oligomer layer.

In some embodiments, the hydrophilic treatment includes one of: a gas phase plasma treatment; a wet chemical oxidization treatment; a corona discharge treatment; an ozone treatment; and an ultraviolet light irradiation treatment.

In some embodiments, the system transfers an oligomer layer on the treated first surface or the treated second surface by using one of: prepolymer transfer; contact transfer; lamination; and spin-coating.

In some embodiments, the system treats the first PDMS oligomer layer and the second oligomer layer for hydrophilic activation prior to bringing the first oligomer layer into contact with the second oligomer layer.

In some embodiments, the hydrophilic activation treatment includes one of: a gas phase plasma treatment; a wet chemical oxidization treatment; a corona discharge treatment; an ozone treatment; and an ultraviolet light irradiation treatment.

In some embodiments, the system allows the two oligomer layers to adhere and form a single bonding layer through a capillary interaction and a self-alignment interaction between the two oligomer layers.

In some embodiments, each of the first substrate and the second substrate can be: a metal substrate; a ceramic substrate; a semiconductor substrate; a thermoplastic substrate; or a thermoset polymer substrate.

In some embodiments, the system patterns the first and second oligomer layers using a micro-nanolithography process prior to bringing the first oligomer layer into contact with the second oligomer layer.

In some embodiments, each of the first and second oligomer layer has a thickness between 0.5 nm and 50 nm.

In some embodiments, the single bonding layer is both electrically conductive and thermally conductive, wherein the electrical conductivity happens in the transverse direction, perpendicular to the coating due to dielectric breakdown, and is highly resistive within the plane.

One embodiment of the present invention provides a system for integrating two chip devices. During operation, the system forms a first liquid layer on a first surface of a first chip device. The system then brings a second surface of a second chip device into contact with the first liquid layer on the first surface of the first chip device, wherein the first liquid layer causes an capillary interaction between the first surface and the second surface. Next, the system allows a first force component of the capillary interaction to align the first chip and the second chip in a lateral direction parallel to the first surface and the second surface. Furthermore, the system allows a second force component of the capillary interface to pull the first surface and the second surface into direct contact as the first liquid layer evaporates, thereby bonding the first chip device and the second chip device into a single device.

In some embodiments, the system forms a second liquid layer on the second surface of the second chip device prior to bringing the second surface of the second chip device into contact with the first liquid layer.

In some embodiments, the first chip device is fixed in place.

In some embodiments, the system brings the second chip device into contact with the first chip device by bringing the second chip device toward the first chip device from the bottom of the first chip device.

In some embodiments, the second chip device is suspended from the first chip device through the capillary interaction.

In some embodiments, the system coats the first surface with a polydimethylsiloxane (PDMS) oligomer adhesive layer prior to forming the first liquid layer on the first surface of the first chip device.

In some embodiments, the system patterns the PDMS oligomer adhesive layer using a micro-nanolithography process.

In some embodiments, the PDMS oligomer adhesive layer has a thickness between 0.5 nm and 50 nm.

### BRIEF DESCRIPTION OF THE FIGURES

FIG. 1 illustrates an exemplary process flow of bonding two arbitrary substrates using the PDMS oligomer layers as an interfacial adhesive in accordance with some embodiments described herein.

FIG. 2A illustrates the correlation between the interfacial hydrophilicity and the power level of oxygen plasma (i.e., the first oxygen plasma in FIG. 1) in accordance with some embodiments described herein.

FIG. 2B illustrates the correlation between the bonding strength and the oxygen plasma power in accordance with some embodiments described herein.

FIG. 2C illustrates the correlations between the PDMS/substrate contact time and the PDMS oligomer layer thickness/contact angle in accordance with some embodiments described herein.

FIG. 2D illustrates the correlation between the bonding strength and PDMS/substrate contact time in accordance with some embodiments described herein.

FIG. 2E illustrates the correlations between the curing temperature and the contact angle/bonding strength in accordance with some embodiments described herein.

FIG. 2F illustrates the correlations between the mixture ratio and the contact angle/bonding strength in accordance with some embodiments described herein.

FIG. 3A presents the results of contact angle measurement to evaluate the interfacial property of various polymeric and non-polymeric substrates prior to performing bonding in accordance with some embodiments described herein.

FIG. 3B illustrates the measured bonding strengths between a variety of different material types in accordance with some embodiments described herein.

FIG. 4A illustrates exemplary micro- and nanopatterns created on the PDMS oligomers formed on single-crystal silicon substrates in accordance with some embodiments described herein.

FIG. 4B illustrates the effect of the pitch dimensions of the patterns on the thickness of PDMS oligomer layer in accordance with some embodiments described herein.

FIG. 5 illustrates an exemplary process flow of bonding two substrates using both the PDMS oligomer layers and the bi-functionalized molecule layers as interfacial adhesives in accordance with some embodiments described herein.

FIG. 6 illustrates an exemplary process flow of bonding two substrates using both the PDMS oligomer layers and the Silane-based second bonding layers as interfacial adhesives in accordance with some embodiments described herein.

FIG. 7 illustrates the principle of the CAP while bonding two substrates in accordance with some embodiments described herein.

FIG. 8 presents a flowchart illustrating a process of integrating two chip devices in accordance with some embodiments described herein.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Some embodiments of the present invention provide PDMS-assisted interfacial bonding techniques for bonding a wide range of homogeneous and heterogeneous surfaces. Moreover, the proposed interfacial bonding techniques facilitate achieving highly localized bonding formation with a nanometer precision, which can be readily employed in rapid growing micro-nanoengineering applications. More specifically, the present techniques utilize the intrinsic transferrable and adhesive natures of the PDMS oligomer layer and flexible surface modification to establish strong interfacial chemical linkage between homogeneous or heterogeneous substrate pairs. The proposed bonding techniques can offer a number of advantages over existing bonding techniques: (1) high bonding strength (up to 400 kPa in some applications) can be achieved on various substrate pairs within or across different material categories; (2) the PDMS oligomer layers can have a thickness of a only few nanometers and have no direct impact on existing surface structures; (3) the imprinting of the PDMS oligomer layer is compatible with micro-nanopatterning techniques (e.g. micro-contact printing and stereomask lithography) and allows for highly localized adhesion formation; (4) the bonding process requires neither thermal nor mechanical treatment, which can be advantageous for biologically oriented applications.

Introduction of soft lithography in micro- and nanofabrication has made Polydimethylsiloxane (PDMS) one of the most popular processing materials for micro-nano researches. PDMS combines low surface energy, mechanical flexibility, optical transparency, and easy molding capacity with a nanometer resolution, in addition to its low price-tag. Moreover, PDMS allows for easy surface modification by creating hydroxyl groups on the side chains through oxygen plasma or acidic treatment, and thus, can establish strong covalent linkages to an identical surface. Replica molded PDMS structures have been extensively employed to create micro-nanomolecular patterns on the specific substrates, known as micro-contact printing. However, accompanied with the targeted molecular inks imprinted, a layer of PDMS oligomer has also been found on the transferred surfaces, which is often considered as undesired residues. The layer of PDMS oligomer obtained during the micro-contact printing process typically possesses certain characteristics, including: (1) a nanometer-thickness with intrinsic hydrophobicity (e.g., between a few tenth of a nanometer to tens of nanometers); (2) excellent adhesion to the substrate (e.g., from 100 kPa to over 400 kPa); (3) ubiquitous presence upon contact with various substrates; and (4) strong dependence on interfacial physiochemistry (e.g., hydrophilicity and molecular polarity).

### PDMS-Assisted Interfacial Bonding of Two Arbitrary Substrates

In some embodiments of the present invention, we utilize the intrinsic transferrable and adhesive natures of the PDMS oligomer layer as a universal interfacial adhesive to bond a group of commonly used micro-nanofabrication materials or substrates. Using the proposed technique, a wide range of substrate pairs can be bonded successfully, wherein the substrate materials, representing ones within and across different materials categories, can include, but are not limited to metals, ceramics, thermoset and thermoplastic polymers. Moreover, the ultrathin adhesive layer of PDMS oligomer can be patterned with a nanometer resolution by adapting the conventional micro-contact printing techniques, which permits forming highly localized adhesion without compromising the existing structural dimensions.

In some embodiments, the proposed PDMS-assisted interfacial bonding technique is used to bond two arbitrary substrates. During operation, the surface of each of the two substrates to be bonded is treated with hydrophilic modification. Techniques for such hydrophilic treatment can include, but are not limited to: a gas phase plasma treatment; a wet chemical oxidization treatment; a corona discharge treatment; an ozone treatment; and an ultraviolet light irradiation treatment. In one embodiment, an oxygen plasma treatment is applied to the surfaces of the substrates to introduce hydroxyl groups on the target surfaces. After the treatment, the target surfaces become hydrophilic.

Next, a thin PDMS oligomer layer is transferred onto each of the modified hydrophilic surfaces. In one embodiment, transferring the PDMS oligomer layer onto the modified hydrophilic surface involves stamping the surface with a planar or micro-/nano-patterned PDMS stamp, during which the PDMS oligomer layer forms upon physical contact between the surface and the PDMS stamp. In the embodiment, the PDMS stamp is subsequently removed from the hydrophilic surface after the PDMS oligomer layer is successfully transferred.

Subsequently, a second hydrophilic treatment is applied to both PDMS oligomer layers on the target substrates for hydroxyl activations on the surfaces of the substrates. Next, two substrates can be bonded by bringing the two activated PDMS oligomer layers into contact, thereby allowing the two PDMS oligomer layers to adhere and form a single bonding layer between the target substrates. Bonding tests have shown consistently strong interfacial adhesion from all material substrate pairs with the PDMS oligomer modification within and across different materials categories, and the strength of the PDMS-assisted interfacial bonding approaches to that of the standard PDMS-to-PDMS bonding.

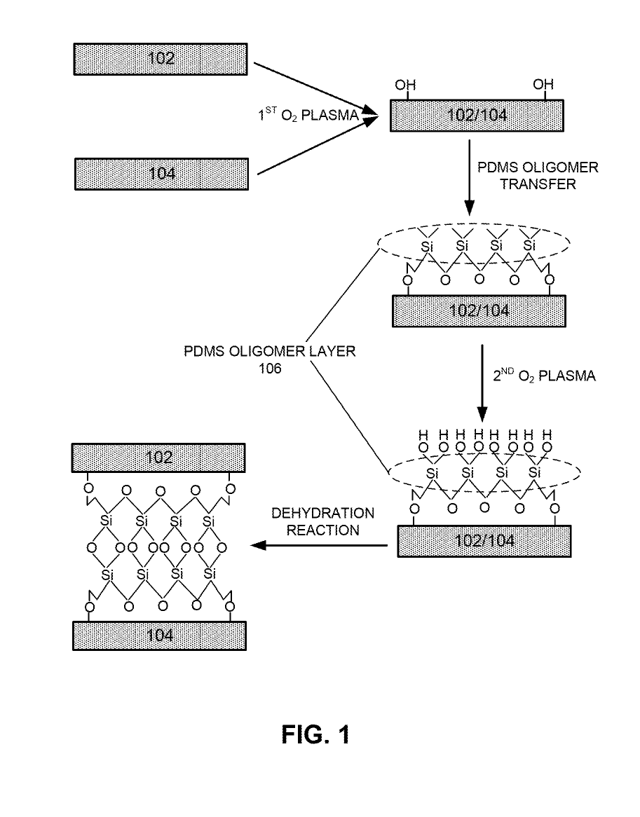

FIG. 1 illustrates an exemplary process flow of bonding two arbitrary substrates using the PDMS oligomer layers as an interfacial adhesive in accordance with some embodiments described herein.

As illustrated in FIG. 1, a pair of substrates (102 and 104) is first treated with an oxygen plasma process for hydroxyl (OH) activation. Note that while oxygen plasma is shown in this example, other embodiments can use different techniques to perform hydrophilic treatment on the substrate surfaces. Note also that because the process flow is substantially identical to both substrates 102 and 104, a simplified notion “102/104” is used to represent the substantially identical process flows on both substrates. After the hydrophilic treatment, cured PDMS stamps, either planar or patterned (not shown in FIG. 1), are brought into contact with the hydroxylated substrates 102 and 104. During the contact printing step, a thin layer of unreacted divinyl PDMS oligomers 106 (i.e., uncrosslinked PDMS base) is transferred and immobilized onto the chemically functionalized substrates 102 and 104 through potential chemical reactions between the vinyl and hydroxyl groups. In one embodiment, each of PDMS oligomer layers 106 has a mer number between 20 and 90. Subsequently, the PDMS stamps are removed from the substrates 102 and 104.

Following removal of the PDMS stamps, the second oxygen plasma treatment is applied to both PDMS oligomer-coated substrates for hydroxyl activation on the surface of each of PDMS oligomer layer 106. Finally, substrates 102 and 104 are mechanically loaded face-to-face with intimate contact. As a result, covalent bonds are forms between the two substrates through dehydration reactions between hydroxyl groups on each of the PDMS oligomer surfaces, whereby bonding substrates 102 and 104 together.

It is understood that the quality of the PDMS-assisted interfacial bonding through the nanometer-thick (PDMS oligomer) adhesive layers is directly associated with two interfaces: the substrate-oligomer and oligomer-oligomer interfaces. Various processing parameters, including plasma power, contact duration, curing ratio and temperature of PDMS pre-polymers, can play important roles in determining the physiochemical properties of the interfacial adhesive layers and therefore overall bonding strengths. Specifically, the power of oxygen plasma strongly affects hydroxyl group activation. The density of activated hydroxyl groups is closely related to the potential chemical linkages between PDMS oligomers (with vinyl groups) and the hydroxylated substrates during the imprint step, and therefore substantially influences the bonding performance at the substrate-oligomer interface (along with other intermolecular interactions, e.g., hydrogen interaction and van der Waals forces). Moreover, the contact time between the substrate and PDMS stamps can influence the molecular diffusion of PDMS oligomers during the transfer. In addition, the mixing ratio and curing temperature of PDMS pre-polymer can determine availability of PDMS oligomers for chemical bonding and transferring.

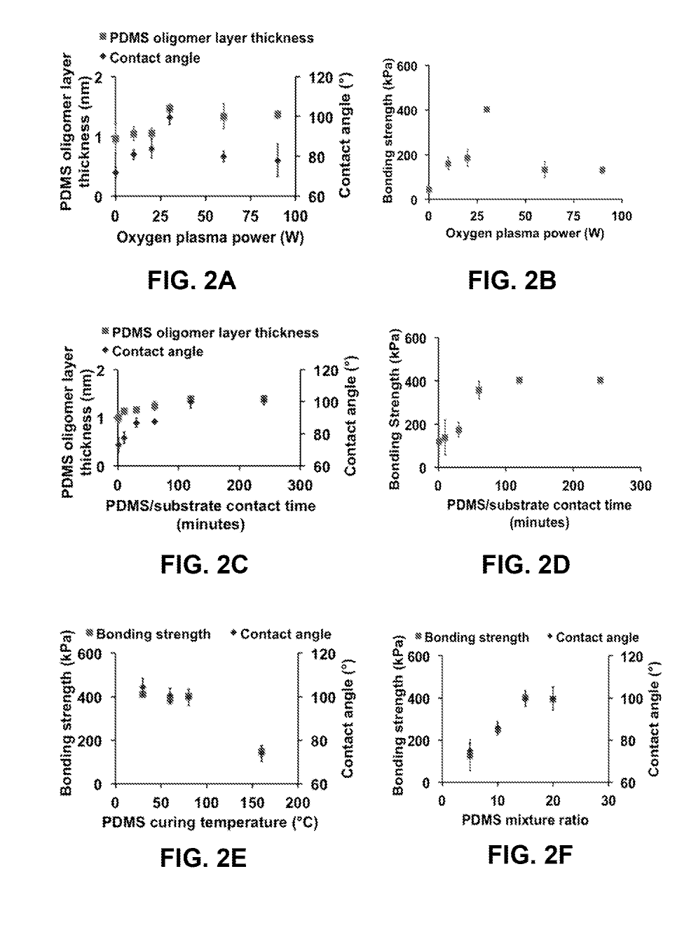

As mentioned previously, PDMS oligomers are preferentially imprinted on hydrophilic surfaces over hydrophobic regions. Oxygen plasma treatment provides a convenient way to render arbitrary substrates hydrophilic, which can promote the adhesion at the substrate-oligomer interface. FIG. 2A illustrates the correlation between the interfacial hydrophilicity and the power level of oxygen plasma (i.e., the first oxygen plasma in FIG. 1) in accordance with some embodiments described herein. As can be seen in FIG. 2A, the contact angle of the substrate and the thickness of the transferred PDMS oligomer layer vary with the plasma power (from to 0 W to 90 W) at a given processing time (of 30 sec). Moreover, the thickness of the transferred oligomer layer follows a similar trend as the contact angle measurement, which is correlated to the density of the activated hydroxyl groups. Further, the differences in interfacial properties lead to the variation in bonding performance, as this process establishes the oligomer-substrate interface in the model. The observed bonding strength is closely correlated with the contact angle and oligomer thickness measurements.

FIG. 2B illustrates the correlation between the bonding strength and the oxygen plasma power in accordance with some embodiments described herein. As illustrated in FIG. 2B, the bonding strength maximized around 400 kPa at the power level of 30 W in this particular experiment. Accordingly, the contact angle and the oligomer thickness on the surfaces without plasma activation may be minimum measured values, possibly indicating partial inhibition of the oligomer transfer by the intrinsic hydrophobicity of the substrate.

FIG. 2C and FIG. 2D illustrate the interfacial impacts on the bonding quality by various contact times between the PDMS stamp and the substrate (i.e., the PDMS oligomer transfer step in FIG. 1), during which PDMS oligomers diffuse from the bulk PDMS block to the interface. More specifically, FIG. 2C illustrates the correlations between the PDMS/substrate contact time and the PDMS oligomer layer thickness/contact angle in accordance with some embodiments described herein. Note that both the PDMS oligomer layer thickness (measured by ellipsometry) and the contact angle show positive correlations with the contact time increase. Based on these results, the contact angle changes more rapidly than the thickness, possibly due to the limited lateral resolution of ellipsometry, which only provides an average thickness over a microscale region and is insensitive to any nanoscopic features.

Alternatively, the contact angle measurement can be highly sensitive to the interfacial properties of a surface both chemically and physically. Therefore, considerable rise in the contact angle with less than one hour contact time is likely due to increased coverage and uniformity of oligomers on the surface, consistent with a marginal increase in the reported thickness by ellipsometry. After one hour, the substrate-oligomer interface becomes stable with little change in thickness or contact angle. Interestingly, the surface coverage takes place in a similar timescale to that of PDMS surface hydrophobic recovery after oxygen plasma treatment. FIG. 2D illustrates the correlation between the bonding strength and PDMS/substrate contact time in accordance with some embodiments described herein. These results show that the increased coverage of oligomers promotes the density of the chemical bond formation and further improve the bonding strength. As shown in FIG. 2D, the overall bonding strength rises from 100 kPa to 400 kPa prior to one hour and then reaches a maximum when the thickness and contact angle become stable with the extended contact time. These results show that the contact time of oligomer transfer plays an important role in establishing a uniform adhesive layer, and significantly impacts the bonding performance at the oligomer-oligomer interface by increasing the bonding density between substrates. It is worth noting that according to the collective analyses in all processing parameters, the thickness of the oligomer layer has shown a consistently positive correlation with the bonding strength. It can be of particular importance to extend the range of intimate contact (typically within 1 nm) for intermolecular interaction (e.g. hydrogen bond) and further dehydration reactions between surfaces, given the presence of physical roughness on the surfaces.

In addition, processing parameters of PDMS stamps, such as mixing ratio of PDMS pre-polymer and curing temperature, are analyzed and plotted in FIGS. 2E and 2F to determine their role in the interfacial bonding. More specifically, FIG. 2E illustrates the correlations between the curing temperature and the contact angle/bonding strength in accordance with some embodiments described herein. FIG. 2F illustrates the correlations between the mixture ratio and the contact angle/bonding strength in accordance with some embodiments described herein. As shown in these plots, decreasing the curing temperature and increasing the mixture ratio (of the base to curing agents) both lead to rising contact angle and improved bonding strength. Possible explanations of these trends are that more oligomers are present on the surface or more effective oligomer diffusion is permitted by the larger PDMS mesh size at lower curing temperatures and higher mixing ratios. These parameters will directly influence the quality of the substrate-oligomer interface by increasing the bond density, analogous to the effects of contact time in FIG. 2C.

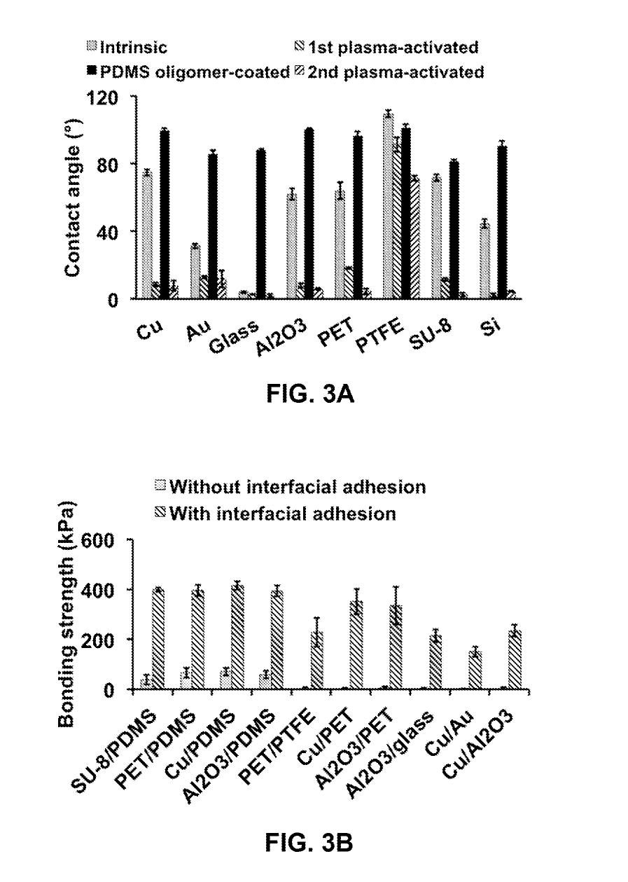

Experimentally, the above-described PDMS-assisted interfacial bonding technique has been demonstrated on a number of traditionally hard-to-bond material pairs within and across the following material categories: metals (Cu and Au), semiconductors (Si), ceramics (Al₂O₃ and glass), and thermoplastic (polyethylene terephthalate, PET and polytetrafluoroethylene, PTFE) and thermoset polymers (PDMS and SU-8), most of which are frequently used in micro-nanofabrication applications. While each material pair undergoes the bonding procedure illustrated in FIG. 1, contact angle measurements are made to infer the change of surface chemistry on the substrates. More specifically, FIG. 3A presents the results of contact angle measurement to evaluate the interfacial property of various polymeric and non-polymeric substrates prior to performing bonding in accordance with some embodiments described herein. As can be seen in FIG. 3A, all substrate materials, except for the chemically inert PTFE, show a dramatic drop in contact angle after the first oxygen plasma treatment, indicating that the surface energy has increased due to surface hydroxylation.

Following the PDMS oligomer imprint step, the similarity of contact angle on different types of material surfaces, close to that of native PDMS, indicates that a layer of PDMS oligomer has been successfully transferred, providing a unilateral surface chemistry for further activation and bonding. The subsequent oxygen plasma activation generates silanol groups on the PDMS oligomer layer and the following dehydration reactions upon contact will link the oligomer layers presented on both surfaces, analogous to the traditional PDMS plasma bonding technique.

According to a given model, the overall bonding strength between heterogeneous material pairs may be limited by either the interfacial substrate-oligomer or oligomer-oligomer adhesion. FIG. 3B illustrates the measured bonding strengths between a variety of different material types in accordance with some embodiments described herein. It is clearly shown that the PDMS-assisted interfacial bonding technique can be not only extended to form strong adhesion between polymer and non-polymer substrates, but also among non-polymer pairs (e.g., Al₂O₃/glass, Cu/Au, and Cu/Al₂O₃). It can also be applied to conventionally hard-to-bond substrates (e.g., PTFE and PET). A relatively strong bonding of over 200 kPa has been repetitively shown using this approach. Among pairs that include one flexible polymer substrate (e.g. PDMS and PET), the bonding strength approaches a maximum of 400 kPa, with the exception of PET/PTFE. These indicate that the adhesion at the oligomer-oligomer interface determines the overall bonding strength among these bonding pairs. For the weaker bonding of the PET/PTFE pair, it is likely limited by the substrate-oligomer interaction, which is supported by the experimental observation of slight changes in interfacial chemistry (implied by contact angle measurement) through the oxygen plasma treatment and oligomer imprint step, indicating that PDMS oligomer transfer was significantly inhibited by the intrinsic chemical inertness of PTFE.

In addition, bonding strength between two stiff non-polymer substrates has been shown to be consistently lower than that of the pairs with a polymeric substrate. This phenomenon is likely explained by the rigidity of the materials and the presence of surface roughness, as any separation formed at the oligomer-oligomer interface will prevent the nanometer-thick oligomer layers from coming in close contact. However, the oligomer-substrate bonding strength is not likely to be the limiting factor in the non-polymer bonding pairs since significant changes in contact angle have been observed when the oligomer layer was transferred to those surfaces, similar to the change in contact angle of the polymeric substrate with excellent substrate-oligomer interface. Therefore, the overall bonding strength of mechanically rigid substrates is likely determined by the incomplete contact for interfacial bonding formation.

### Micro- and Nanopatterned PDMS Oligomer Layers

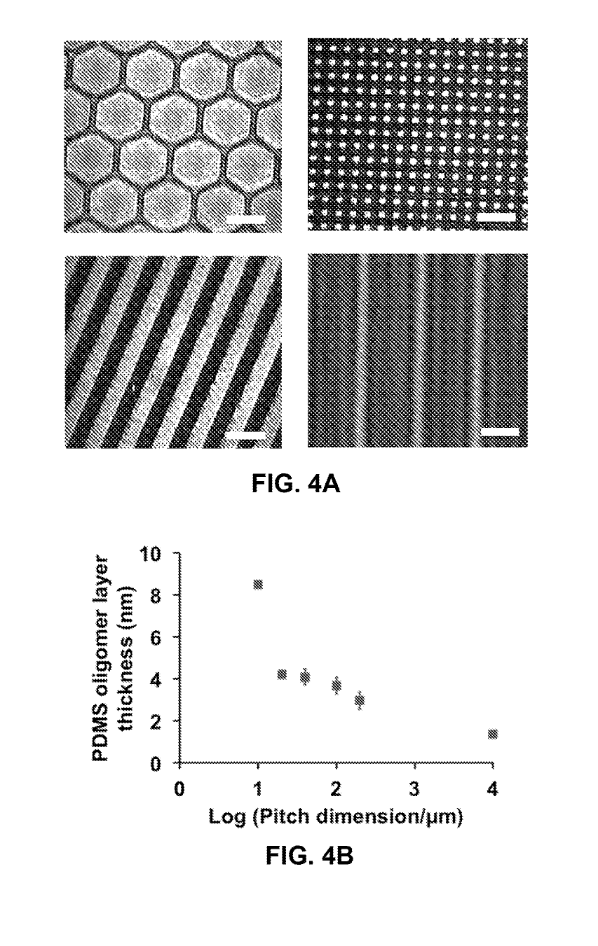

In some embodiments, other than forming planar PDMS oligomer layers on the bonding substrates, each of the PDMS oligomer layers is micro- or nanopatterned onto the substrate to allow highly localized bond formation through the micro-contact printing process. Specifically, the desired patterns of oligomer transfer can be incorporated into a master mold of the PDMS stamp using a lithography-based technique. Subsequently, the molded PDMS is brought into contact with the bonding substrates. Only the embossed PDMS areas are in physical contact with the target substrates where the oligomer patterns are imprinted accordingly. FIG. 4A illustrates exemplary micro- and nanopatterns created on the PDMS oligomers formed on single-crystal silicon substrates in accordance with some embodiments described herein, wherein the single-crystal silicon substrate is chosen as a reflective and atomically smooth surface for the analysis on the nanometer-thick imprinted oligomer layer. FIG. 4B illustrates the effect of the pitch dimensions of the patterns on the thickness of PDMS oligomer layer in accordance with some embodiments described herein.

Note that compared to planar PDMS oligomer transfer (FIGS. 2A-2F), the micro- or nanopatterned PDMS oligomer layer is typically significantly thicker (e.g., 3-8 nm) than the planar PDMS oligomer layer (e.g., 1-2 nm). Moreover, the imprinted oligomer layers present an edge effect, where the thickness along the border is generally higher than that in the middle portion. These two observations, consistent with previous reports on PDMS oligomer residues, could be potentially caused by the non-uniform diffusion of the PDMS oligomer from the patterned stamp that large amounts of PDMS oligomer dampen at the triple interface (substrate/air/PDMS). Furthermore, bonding performance of planar PDMS and SU-8 with a micropatterned oligomer layer (200 μm micropost array) has been experimentally evaluated (371.7±19.6 kPa), which delivers a comparable performance as that of the uniformly coated counterpart (398.7±8.5 kPa). The similarity of both bonding strengths demonstrates the robustness and patternability of the interfacial adhesive joining technique, which could be of particular use in creating micro- and nano-structured surfaces and devices.

### Using a Second Bonding Layer

In the above-described PDMS-assisted interfacial bonding techniques, the two PDMS oligomer layers are used as adhesives such that they are directly brought into contact to form the bonding layer. In some embodiments of the present invention, after transferring the PDMS oligomer layer onto the treated substrate, a second bonding layer is applied onto the PDMS oligomer layer. In these embodiments, the transferred PDMS oligomer layer is typically untreated so that its surface remains hydrophobic. In particular, the second bonding layer is designed such that it interacts strongly with the PDMS oligomer layer to form an interfacial bonding while presenting an outward chemistry that can also interact strongly through a physical interaction with a bonding pair. In one embodiment, the second bonding layer comprises bi-functionalized molecules which comprise both a hydrophobic component for interacting with the untreated PDMS oligomer layer, and a polar component that is used to physically interact and bind to a bonding pair. Such bi-functionalized molecules can include lipid, fat acid, among others. Note that the second bonding layer is similarly applied to the both target substrates.

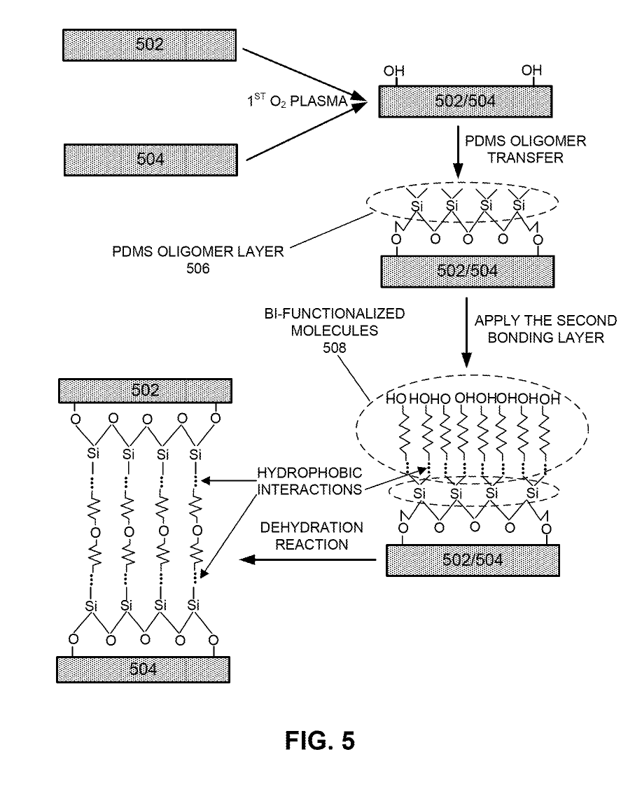

In some embodiments, the polar component is a hydrophilic component. In these embodiments, the hydrophobic components of the bi-functionalized molecules form strong bonds with the hydrophobic surface of the PDMS oligomer layer. The outward facing hydrophilic components of the bi-functionalized molecules are linked to the hydrophobic components through long chemical bonds (illustrated in FIG. 5), which provide significantly more bonding areas than the PDMS oligomer layer itself. Because both target substrates are treated in the same manner, the corresponding outward facing hydrophilic components of the bi-functionalized molecules from both substrates can be strongly bonded to each other through their respective hydrophilic components (e.g., hydroxyl groups), which is facilitated by the long chemical bonds from both substrates.

FIG. 5 illustrates an exemplary process flow of bonding two substrates 502 and 504 using both the PDMS oligomer layers and the bi-functionalized molecules layers as interfacial adhesives in accordance with some embodiments described herein. Note that the part of the process in FIG. 5 from the start until forming PDMS oligomer layer 506 is substantially identical to the process of FIG. 1. However, the process of FIG. 5 does not include the second oxygen plasma, and as such, the outward facing side of PDMS oligomer layer 506 remains hydrophobic in nature. Next, the second bonding layer containing bi-functionalized molecules 508 is applied onto PDMS oligomer layer 506. As a result, the hydrophobic components of the bi-functionalized molecules stick to PDMS oligomer layer 506 through hydrophobic interaction, which is shown in FIG. 5 with dots. Meanwhile, the outward facing hydrophilic components of bi-functionalized molecules 508 are shown as the free OH groups. Finally, substrates 502 and 504 are mechanically loaded face-to-face with intimate contact. As a result, covalent bonds are forms between the two substrates through reactions between hydrophilic groups on each of the substrates, whereby bonding substrates 502 and 504 together. As mentioned above, the long bonds of the bi-functionalized molecules allow such bonding process to occur more easily and the resulting bonding strength stronger.

Note that the outward facing hydrophilic groups in the two bonding layers can be the same or different chemical groups. In one embodiment, the bi-functionalized molecules of the second bonding layer in substrate 502 are of different chemical type from the bi-functionalized molecules of the second bonding layer in substrate 504.

The following discussion provides another technique for using a second bonding layer in addition to the PDMS oligomer layer. In some embodiments of the present invention, after transferring the PDMS oligomer layer onto the treated substrate, and treating the PDMS oligomer layer to introduce hydrophilic groups on the surface of the PDMS oligomer layer, a second bonding layer comprising Silane molecules is applied to the treated PDMS oligomer layer. As a result, the hydrophilic groups in the Silane molecules, such as hydroxyl groups, react with the treated PDMS oligomer layer to form interfacial bonds. In these embodiments, the outward facing chemistry of the Silane molecules is design specific. More specifically, the outward facing chemistry can be designed to be hydrophilic, hydrophobic, ionic (i.e., electrostatic), or magnetic. For hydrophilic designs, the chemical group of Silane molecules can be one of: OH, COOH, NH₂, and other hydrophilic chemical groups. For hydrophobic designs, the chemical group of the Silane molecules can be one of: CH₂, CH₃, CF₃, and other hydrophobic chemical groups.

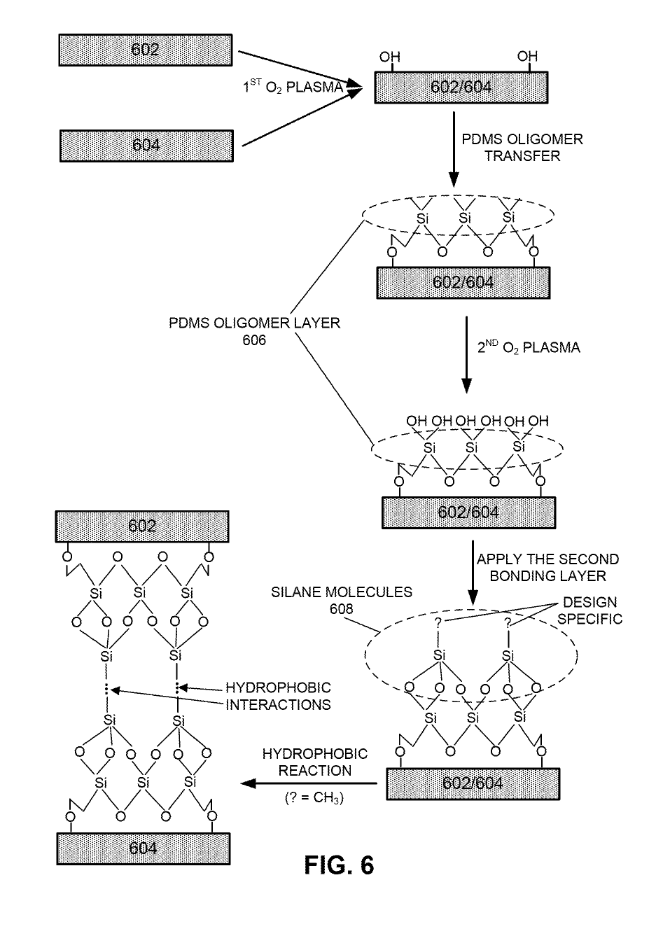

FIG. 6 illustrates an exemplary process flow of bonding two substrates 602 and 604 using both the PDMS oligomer layers and the Silane-based second bonding layers as interfacial adhesives in accordance with some embodiments described herein. Note that the part of the process in FIG. 6 from the start until forming hydrophilic groups on the PDMS oligomer layer 606 is substantially identical to the process of FIG. 1. However, instead of directly bonding the PDMS oligomer layers, a second bonding layer comprising design-specific Silane molecules 608 is applied onto PDMS oligomer layer 606. As a result, the hydrophilic groups in the Silane molecules 606, such as hydroxyl groups, react with the treated PDMS oligomer layer to form interfacial bonds. Meanwhile, the outward facing design-specific chemical groups of Silane molecules 606 are shown with “?” to indicate their design-specific property.

While a Silane-based second bonding layer is applied to each of the two substrates 602 and 604, the two Silane-based second bonding layers are not necessarily identical. More specifically, if the design specific chemical groups in the Silane molecules of the first substrate is hydrophilic, the design specific chemical groups in the Silane molecules of the second substrate is typically also hydrophilic. On the other hand, if the design specific chemical groups in the Silane molecules of the first substrate is hydrophobic, the design specific chemical groups in the Silane molecules of the second substrate is typically also hydrophobic. However, the chemical groups of the Silane-based bonding layers on the two target substrates do not have to be of the same type, as long as chemical bonds or strong molecular interactions (e.g. hydrophobic interaction, hydrogen bond, electrostatic interaction) can be formed between the two second bonding layers. Note that, if the design specific chemical groups in the Silane molecules of the first substrate are designed to be positively charged, the design specific chemical groups in the Silane molecules of the second substrate should be negative charged to allow electrostatic interaction to occur between the two substrates.

Finally, substrates 602 and 604 are brought together, and the design-specific chemical groups of the two Silane-based bonding layers react to form bonds between the two substrates. In the embodiment illustrated in FIG. 6, both Silane-based bonding layers are designed to be hydrophobic. As a result, covalent bonds are forms between the two substrates through reactions between hydrophobic groups on each of the substrates, whereby bonding substrates 602 and 604 together. In other embodiments, both Silane-based bonding layers are designed to be hydrophilic, and the bonding occurs through hydrophobic interaction. In yet another embodiment, both Silane-based bonding layers are designed to be ionic, and the bonding occurs through ionic bonding. In a further embodiment, both Silane-based bonding layers are designed to be magnetic, and the bonding occurs through magnetic interaction.

In yet another technique which involves using a second bonding layer in addition to the PDMS oligomer layer, a non-evaporative liquid layer (e.g., ionic liquid) is used. More specifically, this technique begins with the steps of the basic technique of transferring the PDMS oligomer layer onto the treated substrate, and selectively treating the PDMS oligomer layer to introduce hydrophilic patterns on the surface of the PDMS oligomer layer. Next, the patterned hydrophilic surface of one or both of the PDMS oligomer layers is coated with non-evaporative liquid, such as ionic liquid. The thickness of the non-evaporative liquid layer may be controlled by controlling either the volume of the non-evaporative liquid applied to the hydrophilic surface or the surface chemistry (e.g., a degree of hydrophilicity), or by controlling both. Subsequently, the two target substrates are brought into contact, whereby the two hydrophilic surfaces are jointed by the non-evaporated liquid through the capillary force created by the non-evaporated liquid to achieve the bonding between the two substrates. Note that the non-evaporative liquid becomes a permanent part of the interfacial bonding of the two bonded substrates.

Bonding Two Substrates with Self-Alignment/Self-Engagement Mechanism

Some embodiments of the present invention provide a simple-to-operate, easy-to-adapt alignment technique for aligning two target substrates during the bonding process. We refer to this alignment technique as capillary-driven automatic packaging (CAP), because it utilizes structurally directed capillary interactions to establish both bottom-to-top self-alignment and self-engagement in a single-step automatic process. Similar to the well developed capillary-assisted self-assembly, the acting capillary interactions are enabled by an intermediate liquid layer confined in between two parallel surfaces with identical wetting boundaries, and position and orient the surfaces spontaneously.

The structurally defined wetting boundaries have been both theoretically and experimentally investigated to achieve the optimal self-alignment performance as the capillary force increases linearly with the capillary length. Moreover, the capillary bridge formed between two surfaces results in elevated Laplace pressure (negative) for the surface self-engagement, as the sandwiched liquid film gradually evaporates (and the film thickness reduces too). As a consequence, two surfaces are brought into intimate contact and form seamless joints through covalent bonding of pre-activated functional groups on surfaces, which have been described in conjunction with FIGS. 1-6. Unique advantages of CAP are summarized as follows: (1) the aligning and bonding can be achieved spontaneously through an evaporating capillary bridge in one single step; (2) the alignment structure can be incorporated in the same layer of the main structure (no additional layer or patterning is needed); (3) it can be adopted to multilayer microstructure assembly with high alignment resolution and excellent bonding performance; (4) the automatic packaging process can be potentially scaled up without using any dedicated fabrication equipment; (5) it can be applied to various new structural materials and unconventional fabrication techniques, as long as the bonding mechanism is compatible with the liquid capillary bridge; and (6) neither mechanical nor thermal treatment process is involved, which is desired in highly sensitive chemical and biological applications.

The proposed capillary-driven automatic packaging (CAP) utilizes interfacial capillary interactions between the top and bottom surfaces and the intermediate liquid layer to establish both self-alignment and self-engagement in the packaging process, extended from the basic principle of the capillary-driven self-assembly. Specifically, the capillary interactions include two force components, capillary force (F_{C}) along the wetting boundaries and suction force (F_{S}) from the negative Laplace pressure (ΔP) inside induced by liquid menisci.

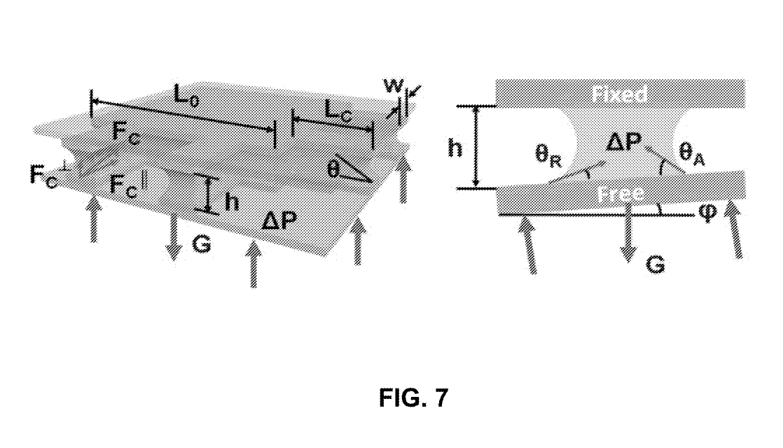

FIG. 7 illustrates the principle of the CAP while bonding two substrates in accordance with some embodiments described herein. As shown in FIG. 7, the lateral component of the capillary force (F_{C}^{∥}) attempts to spontaneously align the identical comb-shaped wetting patterns between two surfaces in order to minimize liquid surface energy. Meanwhile, the suction force together with the perpendicular component of the capillary force (F_{C}^{⊥}) would gradually bring the two surfaces into intimate contact, as the capillary bridge continuously evaporates. However, presence of the gravitational force (G) of the substrate can lead to potential misalignment as often the surface is not perfectly perpendicular to the gravitational plane. In order to maintain a negative adhesive pressure against the gravity on the moving part, some embodiments of the present invention employ a bottom-to-top self-alignment scheme: wherein the top surface is affixed in place, while the capillary-suspended bottom substrate is gradually driven towards the fixed top surface through the capillary interaction, as evaporation continues. This is a clear distinction between the proposed CAP process and the conventional packaging techniques.

Note that in the proposed self-alignment technique, the physical forces involved in the CAP process include the capillary force F_{C}, the suction force ΔP, and the gravitational force G of the bottom substrate. These force components can be expressed in Eqn (1a) and (1b), under the assumption that the alignment-related movement is relatively small, and therefore, the motion-induced friction is negligible:

$$\begin{matrix}{F}_{C} = γ D , & ( 1 a ) \\ {F}_{s} = Δ PA = \frac{2 γ cos θ}{h} A , & ( 1 b )\end{matrix}$$

wherein the perimeter D and area A of the hydrophilic capillary region for self-alignment can be computed as D=Lo+2nL_{c}, and A=Lₒ²+4nwL_{c}, accordingly (n is the number of the comb-shaped structures), as illustrated in FIG. 7. (L_{c} and w indicate the length and width of the comb-shaped alignment structures, respectively, and L_{c} is the length of the baseline structure. γ and θ indicate the surface tension and contact angle of the intermediate fluid, respectively, and h is the height of the capillary bridge).

As mentioned above, the lateral component of the capillary force (F_{C}^{∥}) can be used to minimize the overall surface energy of the capillary fluidic layer and to position the top and bottom substrates through the identical comb-shaped wetting patterns for automatic alignment. As shown in Eqn (1a), the strength of the capillary force is proportional to the length of the wetting boundary and the surface tension of the liquid. Therefore, adding or extending the comb-shaped microstructures (e.g., increasing n or L_{c}) can increase the overall capillary force. In the case when the bottom surface is not completely perpendicular to the gravity, the parallel component to the surface can drag the substrate off from its aligned position, from which the force balance can be expressed as:

G sin φ=F_{C}(cos θ_{R}−cos [symbol] θ_{A}) [symbol] , (2a)

where φ is the tilting angle of the bottom substrate, θ_{A} and θ_{R} represent the advancing and receding contact angles of the menisci, respectively. As a result, the misalignment (Δx) between two substrates can be quantitatively calculated as:

$$\begin{matrix}Δ x = \frac{h ( sin {θ}_{A} - sin {θ}_{R} )}{( cos {θ}_{A} - cos [ {θ}_{R} ) ]} \\ = ( G / {F}_{C} ) ( h sin \frac{ϕ}{2} sin ( \frac{{θ}_{A} + {θ}_{R}}{2} ) )\end{matrix} \qquad ( 2 b )$$

Self-engagement simply relies on the suction pressure from the intermediate liquid layer as shown in Eqn (1b). As liquid in the capillary bridge continues evaporating, its height gradually reduces and the negative pressure rises inside as predicted by Laplace equation. As previously reported, the pressure inside capillary bridges can be as high as −17 bar, which provides significant and uniform lifting (hydrostatic nature) force for the bottom substrate to establish close physical contact with the top for the subsequent covalent bonding between two functionalized surfaces. Eqn (3) shows the relationship among the three related forces:

G cos φ≦2F_{C}(sin θ_{A}+sin [symbol] θ_{R}) [symbol] +F_{S}. (3)

It is worth noting that the Laplace pressure inside the capillary bridge drives the bottom substrate towards the fixed top surface, which can be considerably greater than the gravitational force.

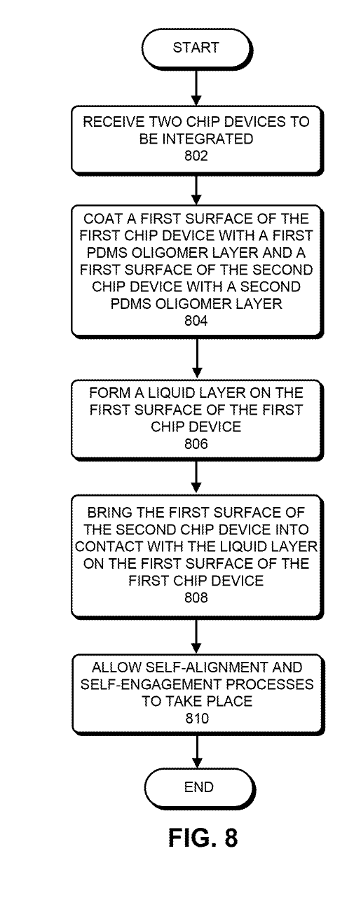

FIG. 8 presents a flowchart illustrating a process of integrating two chip devices in accordance with some embodiments described herein. During operation, the system receives two chip devices: the first chip device and the second chip device to be integrated (step 802). Note that each of the chip devices is constructed on a substrate, wherein the two substrates can be made of the same material or different materials.

Next, the system coats a first surface of the first chip device with a first PDMS oligomer adhesive layer and also coats a first surface of the second chip device with a second PDMS oligomer adhesive layer (step 804). Note that the system can coat the first and second chip device with the PDMS oligomer adhesive layers using the PDMS oligomer layer transfer technique described in conjunction with FIG. 1. In one embodiment, each of the PDMS oligomer adhesive layers has a thickness between 0.5 nm and 50 nm. In one embodiment, the first and second PDMS oligomer adhesive layers are planer layers. In another embodiment, the first and second PDMS oligomer adhesive layers are micro-/nanopatterned layers.

The system then forms a liquid layer on the first surface of the first chip device (step 806). In one embodiment, the liquid is an evaporative liquid. In some embodiments, the system optionally forms a liquid layer on the first surface of the second chip device.

Next, the system brings the first surface of the second chip device into contact with the liquid layer on the first surface of the first chip device, wherein the liquid layer causes a capillary interaction between the first surface of the first chip device and the first surface of the second chip device (step 808). In one embodiment, the first chip device is fixed in place and the first surface with the liquid layer is facing downward. In this embodiment, bringing the second chip device into contact with the first chip device involves bringing the second chip device toward the first chip device from the bottom of the first chip device.

After the two chip devices are engaged through the capillary interaction, a self-alignment process takes place between the two chip devices through a lateral force component of the capillary interaction, which causes the first chip device and the second chip device to align in a lateral direction parallel to the chip surfaces. Furthermore, a self-engagement process takes place between the two chip devices through a perpendicular force component of the capillary interaction, which pulls the first surface and the second surface increasingly closer and eventually into direct contact as the liquid layer evaporates, thereby bonding the first chip device and the second chip device into a single device (step 810).

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

1. A method for bonding a first substrate and a second substrate, the method comprising:
treating a first surface of the first substrate and a second surface of the second substrate with a hydrophilic treatment;
transferring a first oligomer layer onto the treated first surface and a second oligomer layer onto the treated second surface; and
bringing the first oligomer layer into contact with the second oligomer layer, thereby allowing the two oligomer layers to adhere and form a single bonding layer between the first substrate and the second substrate.

2. The method of claim 1, wherein each of the first oligomer layer and the second oligomer layer is a polydimethylsiloxane (PDMS) oligomer layer.

3. The method of claim 2, wherein transferring a PDMS oligomer layer on the treated first surface or the treated second surface involves imprinting a PDMS stamp on the treated first surface or the treated second surface to cause a PDMS oligomer layer to form on the treated first surface or the treated second surface.

4. The method of claim 3, wherein after transferring the PDMS oligomer layer on the treated first surface or the treated second surface, the method further comprises removing the PDMS stamp from the PDMS oligomer layer.

5. The method of claim 1, wherein the hydrophilic treatment includes one of:
a gas phase plasma treatment;
a wet chemical oxidization treatment;
a corona discharge treatment;
an ozone treatment; and
an ultraviolet light irradiation treatment.

6. The method of claim 1, wherein transferring an oligomer layer on the treated first surface or the treated second surface involves using one of:
prepolymer transfer;
contact transfer;
lamination; and
spin-coating.

7. The method of claim 1, wherein prior to bringing the first oligomer layer into contact with the second oligomer layer, the method further comprises treating the first PDMS oligomer layer and the second oligomer layer for hydrophilic activation.

8. The method of claim 7, wherein the hydrophilic activation treatment includes one of:
a gas phase plasma treatment;
a wet chemical oxidization treatment;
a corona discharge treatment;
an ozone treatment; and
an ultraviolet light irradiation treatment.

9. The method of claim 1, wherein allowing the two oligomer layers to adhere and form a single bonding layer involves a capillary interaction and a self-alignment interaction between the two oligomer layers.

10. The method of claim 1, wherein each of the first substrate and the second substrate can be:
a metal substrate;
a ceramic substrate;
a semiconductor substrate;
a thermoplastic substrate; or
a thermoset polymer substrate.

11. The method of claim 1, wherein prior to bringing the first oligomer layer into contact with the second oligomer layer, the method further comprises patterning the first and second oligomer layers using a micro-nanolithography process.

12. The method of claim 1, wherein each of the first and second oligomer layer has a thickness between 0.5 nm and 50 nm.

13. The method of claim 1, wherein the single bonding layer is both electrically conductive and thermally conductive, wherein the electrical conductivity happens in the transverse direction, perpendicular to the coating due to dielectric breakdown, and is highly resistive within the plane.

14. A system that bonds a first substrate and a second substrate, comprising:
a treatment mechanism configured to treat a first surface of the first substrate and a second surface of the second substrate with a hydrophilic treatment;
a transferring mechanism configured to transfer a first oligomer layer onto the treated first surface and a second oligomer layer onto the treated second surface; and
a joining mechanism configured to bring the first oligomer layer into contact with the second oligomer layer, thereby allowing the two oligomer layers to adhere and form a single bonding layer between the first substrate and the second substrate.

15. The system of claim 14, wherein each of the first oligomer layer and the second oligomer layer is a polydimethylsiloxane (PDMS) oligomer layer.

16. The system of claim 15, wherein the transferring mechanism is further configured to imprint a PDMS stamp on the treated first surface or the treated second surface to cause a PDMS oligomer layer to form on the treated first surface or the treated second surface.

17. The system of claim 16, further comprising a removing mechanism configured to remove the PDMS stamp from the PDMS oligomer layer after transferring the PDMS oligomer layer on the treated first surface or the treated second surface.

18. The system of claim 14, wherein the hydrophilic treatment includes one of:
a gas phase plasma treatment;
a wet chemical oxidization treatment;
a corona discharge treatment;
an ozone treatment; and
an ultraviolet light irradiation treatment.

19. The system of claim 14, wherein the transferring mechanism includes one of:
prepolymer transfer;
contact transfer;
lamination; and
spin-coating.

20. The system of claim 14, wherein the treatment mechanism is further configured to treat the first PDMS oligomer layer and the second oligomer layer for hydrophilic activation, prior to bringing the first oligomer layer into contact with the second oligomer layer.

21. A method for integrating two chip devices, the method comprising:
forming a first liquid layer on a first surface of a first chip device;
bringing a second surface of a second chip device into contact with the first liquid layer on the first surface of the first chip device, wherein the first liquid layer causes an capillary interaction between the first surface and the second surface;
allowing a first force component of the capillary interaction to align the first chip and the second chip in a lateral direction parallel to the first surface and the second surface; and
allowing a second force component of the capillary interface to pull the first surface and the second surface into direct contact as the first liquid layer evaporates, thereby bonding the first chip device and the second chip device into a single device.

22-28. (canceled)
